(19) United States
(12) Patent Application Publication
(10) Pub. No.: US 2022/0061477 A1
(43) Pub. Date: Mar. 3, 2022

(54) CLASS RING WITH SCHOLASTIC ACHIEVEMENT INDICIA AND METHODS THEREFORE

(71) Applicant: James P. Sanderson, Shelby Township, MI (US)

(72) Inventor: James P. Sanderson, Shelby Township, MI (US)

(21) Appl. No.: 17/458,187

(22) Filed: Aug. 26, 2021

Related U.S. Application Data
(60) Provisional application No. 63/070,561, filed on Aug. 26, 2020.

(51) Int. Cl. A44C 9/00

(52) U.S. Cl. CPC A44C 9/0053

(57) ABSTRACT

Disclosed is a concept of indicating degrees of college scholastic achievement on a class ring, by embellishing the face of a class ring with additional indicia-sized stones seated into the main gemstone of the class ring. Especially, for example, a preferred aspect of scholastic achievement indicia includes an indicia-sized single diamond or other stone indicating achievement of a master's degree, while two stones will indicate a Ph. D doctoral level achievement.

### CROSS-REFERENCE TO RELATED APPLICATIONS

This application claims the benefit under 35 U.S.C. 119(e) of U.S. Provisional Application No. 63/070,561, filed on Aug. 26, 2020.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relates to a concept of indicating degrees of college and/or higher learning scholastic achievement on a class ring, and more particularly, the invention relates to an embellishment to the face of a class ring, wherein additional stones are seated into the main stone of the class ring, especially, for example, a preferred aspect includes a single diamond or other stone indicating achievement of a master's degree, while two stones will indicate a Ph. D doctoral level achievement.

### 2. Description of the Prior Art

Because sales of conventional class rings have been dropping, partly due to the price of gold and other precious metals as well as waning interest, new concepts are needed. Traditional class rings could use a boost in sales by adding new features never addressed before. Previously, class rings were promoted to indicate graduation from college or high school. These rings generally have a semi-precious stone or some other material that looks like a semi-precious stone, usually made from the school colors or the birthstone of the ring wearer. Usually there is writing in the ring portion around the stone, in raised letters, that indicates the year that one graduated, and the name of the educational institution. To date, no one has made a ring with any indication of the level of higher level of scholastic achievement, i.e. to what level of education that the wearer of the class ring has achieved. The present invention seeks to provide indicia of scholastic achievement that is visible to observers of one's ring that they are wearing.

For example, years ago, during the Great Depression of the last century, a jeweler was going through hard times, like so many others. To boost business, he came up with the concept of selling gold retirement watches to employers for gifting to employees with 25 years of service. Then, he began a sales and advertising campaign to promote the proverbial gold watch as a retirement gift. Soon, these achievements became synonymous with those gold watches. It is one of the aspects of the present invention to start a new tradition of securing or inserting indicia of scholastic achievement onto the face of a class ring stone for the purpose of letting the world know about one's hard work to achieve that goal. This is a concept never seen before.

Therefore, the industry of class rings would be enhanced if new concepts for indicating scholastic achievement would be provided to give an advantage to graduates.

### SUMMARY OF THE INVENTION

In accordance with the above-noted advantages and desires of the industry, the present invention provides a visible means on a class ring for conveying and indicating higher levels of scholastic achievement for the world to see. A method of doing business to realize the concept of indicating scholastic achievement in the higher learning realm is disclosed.

Also in accordance with the present invention, a preferred aspect of a method of indicating scholastic achievement is accomplished by displaying an indicia on the face of a class ring worn by the graduate. One look at someone's class ring will tell the observer the level of scholastic achievement of the graduate ring's owner. This method overcomes many of the aforementioned issues with the prior art because an observer can immediately determine if the wearer has a master's degree or a doctorate degree by looking at the number of extra stones evident on the face of the stone in the class ring of the wearer. One specific preferred aspect has certain features including the addition of a seated single diamond in a bezel on the face of the main class ring stone to indicate that a master's degree has been achieved, while, if a doctorate degree has been achieved, two seated single diamonds on the face will provide such an achievement.

While the invention is particularly useful for applications in the class ring industries, and while there are many different university applications that are too numerous to mention here, the most preferred application is described more fully hereinbelow. Methods of securing the indicia stone to the face of the main stone are disclosed in greater detail.

Although the invention will be described by way of examples for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is a front elevational view of a class ring with a single stone in an elongated diamond shaped bezel indicating the scholastic achievement of a master's degree, being made in accordance with the present invention;

FIG. 2 is also a front elevational view of a class ring with a single stone set in a square shaped bezel made in accordance with the present invention; and

FIG. 3 is a front elevational view of a class ring with two stones in square shaped bezels indicating the scholastic achievement of a doctorate level degree, further being made in accordance with the present invention.

### DETAILED DESCRIPTION OF THE INVENTION

The invention involves the concept of making and displaying a class ring with indicia on the face to let others know the level of higher learning that one has achieved. In its preferred aspect, a class ring with a single stone on the face of the main gemstone indicates that the person wearing the ring has achieved a Master's degree, while a class ring with two stones indicates the achievement of a Ph. D doctoral degree. Also within the scope of the present invention would be indicia on rings of other professional achievements, such as certified public accountant, (CPA), professional engineer (PE), certified professional financial planner (CPFP) and the like.

In that regard, a method of indicating higher learning scholastic achievement is herein disclosed for displaying a class ring having at least one indicia of scholastic achievement located on the face of the main gemstone of the class ring, wherein the scholastic achievement indicia includes indicia of scholastic achievement for varying degrees of higher learning to provide viewers of the ring with information about the level of academic higher learning achievement.

In particular, the best mode of the present invention includes displaying the class ring with at least one indicia of scholastic achievement displaying one stone located on the face of the main gemstone of the class ring to indicate the achievement of a Master's Degree, while displaying two stones located on the face of the main gemstone of the class ring indicates the achievement of a Ph. D Doctoral Degree.

In a preferred aspect of the present invention, there is also disclosed a class ring having a main gemstone with a bezel and a face, comprising a wearable class ring, with this wearable ring having at least one indicia of scholastic achievement located on the face of the main gemstone of the class ring, and wherein the scholastic achievement indicia includes indicia of scholastic achievement for varying degrees of higher learning to provide viewers of the ring with information about the level of academic higher learning achievement.

The class ring may be made of a material selected from the group consisting of gold, gold plated metals, silver, sterling silver, silverxt, platinum, stainless steel, austenitic steel, lazon, siladium, valadium radiant yellow 6K alloy, amberxt from Jostens, Inc. of Minnesota, alloys of gold and silver, alloys of silver and platinum, titanium, rhodium plated metals, coated and plated metals and combinations thereof. Or, in some instances, the class ring may be made of a non-precious material such as polymeric and natural materials including nylon, thermoplastics, ceramics, natural wooden and bamboo composites and combinations thereof.

As described hereinabove, the class ring will have at least one indicia of scholastic achievement including one stone located on the face of the main gemstone of the class ring to indicate the achievement of a Master's Degree, or two stones located on the face of the main gemstone of the class ring to indicate the achievement of a Ph. D Doctoral Degree.

The main gemstone is made of a material selected from the group consisting of birthstones, gemstones, synthetic stone materials, polymeric materials, and combinations thereof.

A preferred method of manufacturing such a class ring having a main gemstone with a bezel and a face and having at least one indicia of scholastic achievement of higher learning located on the face of the main gemstone of the class ring includes providing a wearable class ring made of a rigid material. The method of making a class ring having at least one indicia of scholastic achievement located on the face of the main gemstone of the class ring includes first setting an indicia-sized stone into a bezel to provide a combination indicia of scholastic achievement, drilling a recess into the main gemstone and then securing the indicia-sized stone and bezel combination into the recess in the main gemstone.

Lastly, a method of doing business is also imagined by the inventor, including making class rings with the disclosed scholastic achievement indicia, offering such rings to new graduates of higher learning, and providing an advertising campaign to educate the public as well as the recent graduates about the significance of the scholastic achievement indicia.

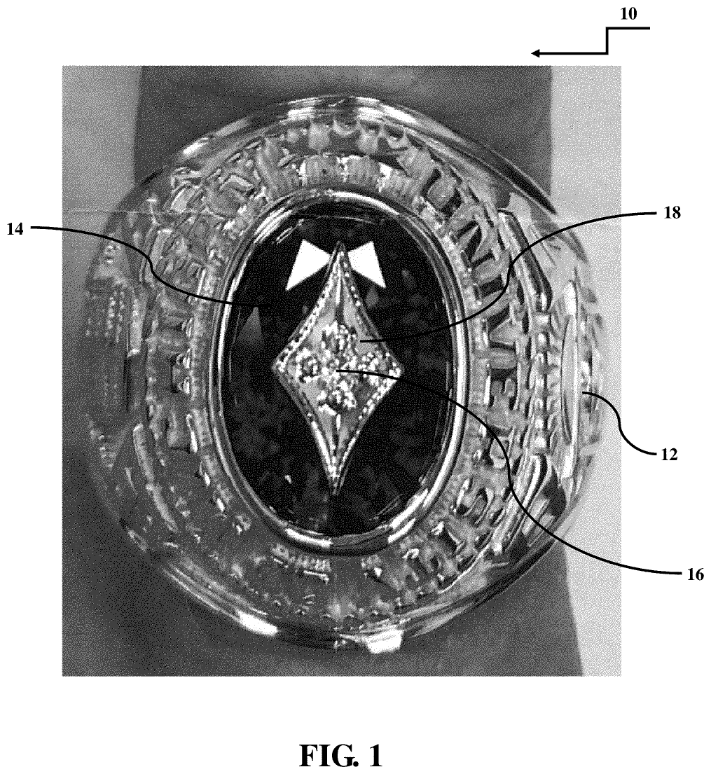

Referring now to the drawings in detail, a preferred aspect of the invention is shown in FIG. 1, which is a front elevational view of a class ring with a single indicia-sized stone is shown in an optional elongated diamond shaped bezel, thereby indicating the scholastic achievement of a master's degree, generally indicated by the numeral 10, which also includes a typical class ring 12 including a main stone 14, now having an indicia-sized stone 16, such as a diamond, within a bezel 18. Such a configuration indicates a master's degree has been achieved.

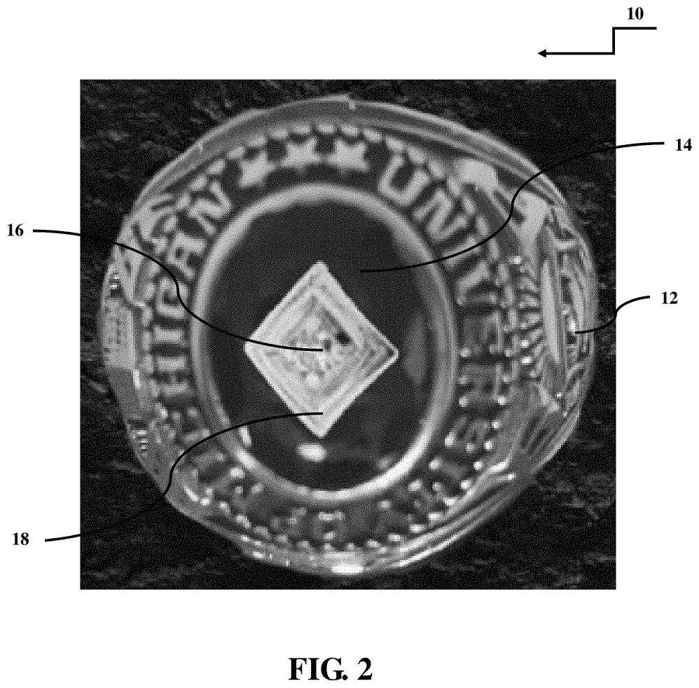

Looking next to FIG. 2, wherein like numerals are displayed from FIG. 1, again the class ring with indicia of scholastic achievement in shown as numeral 10, and includes a typical class ring 12 with a single indicia-sized stone 16 secured in the main gemstone 14. A recess or a through cut (not seen here) is ground into the main stone, and bezel 18 holds stone 16 in place within the recess or through cut, while letting light emit through stone 16 to sparkle. In this aspect, a master's degree indication is once again shown, but now the bezel is of a square-shaped configuration. It is envisioned by the present invention that all shapes of bezel are contemplated, including round, oblong, square, rectangular or any other suitable shape.

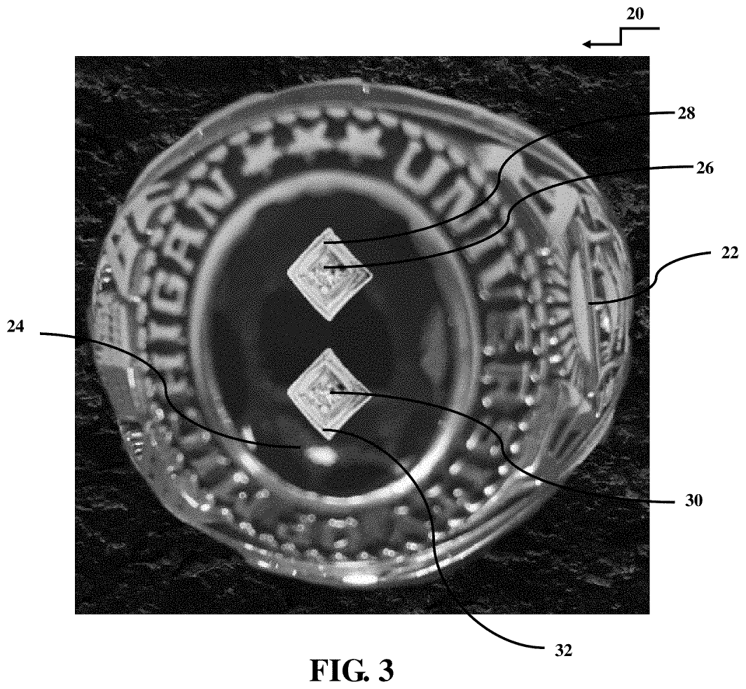

FIG. 3 is a front elevational view of a class ring indicating the achievement of a doctorate or other professional degree. Generally denoted by numeral 20, class ring 22 includes a main stone 24 having first and second stones 26 and 30, respectively, secured within first and second bezels 28 and 32, and then being secured within main stone 24.

It is further contemplated that beyond one or two scholastic achievement stones, more scholastic achievement stones may signify other accomplishments. For example, a single stone may be used for a bachelor's degree, two stones may signify a master's degree, while three stones indicate a doctorate degree. Any preferred sequence of indicia is also contemplated herein.

A preferred method of securing the achievement stones(s) or diamonds is to grind out a recess or drill a hole in the main stone to accommodate the achievement indicia stone or diamond. Preferably, the hole is through the main stone to allow the secured stone to sparkle. Then, securement is accomplished by setting the achievement diamond or stone into a bezel or plate prior to installing or setting the bezel/diamond setting into the main stone, which now provides a visual indication of the level of scholastic achievement for the wearer. Alternatively, the bezel may be secured first, followed by placement of the scholastic achievement stone into the bezel.

Other preferred methods include adhering the scholastic achievement indicia stones to the face of the main stone of the class ring with an adhesive. The scholastic achievement stones may be secured to a decorative bezel, which that combination may then be adhered to the main stone adhesively.

The scope of the present invention includes the use of any suitable or preferred indicia stone that can be set into any suitable size and configuration of bezel or plate that can then be installed into and through the main stone of a class ring. Suitable stones may include diamonds, or any other desired stone or gems such as a ruby, sapphire or other gems. Further, the scholastic achievement stone may be set into an onyx or jade main stone, among other suitable stones that could receive the scholastic achievement stone. In yet another aspect, a substitute main stone can be made of a polymeric material that resembles a semi-precious main stone. Such a polymeric material stone may be preferred as it would be more resistant to cracking or degrading during the drilling process. The bezel may be made of any suitable material as is customary in the jewelry industry and would be configured by jeweler of ordinary skill in the art without undue experimentation.

A method of doing business is also imagined by the inventor, including making class rings with the disclosed scholastic achievement indicia, offering such rings to new graduates of higher learning, and providing an advertising campaign to educate the public as well as the recent graduates about the significance of the scholastic achievement indicia. Among educated consumers, a person wearing such a ring will be recognized in business settings, as well as in social settings.

In summary, numerous benefits have been described which result from employing any or all of the concepts and the features of the various specific aspects of the present invention, or those that are within the scope of the invention. The embellished class ring of the present invention indicates the level of higher learning achieved by the wearer as it is visible to all that view it.

The foregoing description of a preferred aspect of the invention has been presented for purposes of illustration and description. It is not intended to be exhaustive or to limit the invention to the precise form disclosed. Obvious modifications or variations are possible in light of the above teachings with regards to the specific aspects. The disclosed aspects were chosen and described in order to best illustrate the principles of the invention and its practical applications to thereby enable one of ordinary skill in the art to best utilize the invention in various aspects and with various modifications as are suited to the particular use contemplated.

What is claimed is:

1. A method of indicating higher learning scholastic achievement, comprising:
displaying a class ring having at least one indicia of scholastic achievement located on the face of the main gemstone of the class ring,
wherein the scholastic achievement indicia includes indicia of scholastic achievement for varying degrees of higher learning to provide viewers of the ring with information about the level of academic higher learning achievement.

2. The method of claim 1, wherein displaying the class ring with at least one indicia of scholastic achievement includes displaying one stone located on the face of the main gemstone of the class ring to indicate the achievement of a Master's Degree.

3. The method of claim 1, wherein the step of displaying the class ring with at least one indicia of scholastic achievement includes displaying two stones located on the face of the main gemstone of the class ring to indicate the achievement of a Ph. D Doctoral Degree.

4. A class ring having a main gemstone with a bezel and a face, comprising:
a wearable class ring, said wearable ring having at least one indicia of scholastic achievement located on the face of the main gemstone of the class ring,
wherein the scholastic achievement indicia includes indicia of scholastic achievement for varying degrees of higher learning to provide viewers of the ring with information about the level of academic higher learning achievement.

5. The class ring of claim 4, wherein the class ring is made of a material selected from the group consisting of gold, gold plated metals, silver, sterling silver, silverxt, platinum, stainless steel, austenitic steel, lazon, siladium, valadium radiant yellow 6K alloy, amberxt from Jostens, Inc. of Minnesota, alloys of gold and silver, alloys of silver and platinum, titanium, rhodium plated metals, coated and plated metals and combinations thereof.

6. The class ring of claim 4, wherein the class ring is made of a non-precious material such as polymeric and natural materials including nylon, thermoplastics, ceramics, natural wooden and bamboo composites and combinations thereof.

7. The class ring of claim 4, wherein the class ring has at least one indicia of scholastic achievement including one single indicia-sized stone located on the face of the main gemstone of the class ring to indicate the achievement of a Master's Degree.

8. The class ring of claim 4, wherein the class ring includes two indicia-sized stones located on the face of the main gemstone of the class ring to indicate the achievement of a Ph. D Doctoral Degree.

9. The class ring of claim 4, wherein the main gemstone is made of a material selected from the group consisting of birthstones, gemstones, synthetic stone materials, polymeric materials, and combinations thereof.

10. A method of manufacturing a class ring having a main gemstone with a bezel and a face having at least one indicia of scholastic achievement of higher learning located on the face of the main gemstone of the class ring, comprising:
providing a wearable class ring made of a rigid material, said wearable ring having at least one indicia of scholastic achievement located on the face of the main gemstone of the class ring;
setting an indicia-sized stone into a bezel to provide a combination indicia of scholastic achievement;
drilling a recess into the main gemstone; and
securing the indicia-sized stone and bezel combination into the recess in the main gemstone.

11. A method of doing business includes providing class rings with scholastic achievement indicia embellished on the face of the main gemstone of the class ring;
offering such rings to new graduates of higher learning; and
providing an advertising campaign to educate the public as well as the recent graduates about the significance of the scholastic achievement indicia.
